(19) United States
(12) Patent Application Publication
(10) Pub. No.: US 2026/0178539 A1
(43) Pub. Date: Jun. 25, 2026

(54) STORAGE SYSTEM AND METHOD FOR MANAGING COPY PERFORMANCE OF STORAGE SYSTEM

(71) Applicant: Hitachi Vantara, Ltd., Yokohama-shi (JP)

(72) Inventors: Noriko ICHIKAWA, Tokyo (JP); Jun NAKAJIMA, Tokyo (JP); Shinichi HAYASHI, Tokyo (JP)

(73) Assignee: Hitachi Vantara, Ltd., Yokohama-shi (JP)

(21) Appl. No.: 19/302,883

(22) Filed: Aug. 18, 2025

(30) Foreign Application Priority Data
Dec. 23, 2024 (JP) 2024-226570

(51) Int. Cl. G06F 16/11; G06F 16/17; G06F 16/18

(52) U.S. Cl. CPC G06F 16/122; G06F 16/1734; G06F 16/1815

(57) ABSTRACT

To shorten the duration affecting the performance of a storage system, even when a consistency group including multiple journal groups is used, a first storage system performs journaling at least when data is written to a data volume. It defines at least one consistency group comprising several journal groups across multiple storage nodes. When the usage rate of any journal volume within these consistency groups exceeds a predetermined threshold, the system traces to identify the specific journal group to which the journal volume belongs and determines the associated consistency group. Subsequently, it identifies at least one journal volume within this consistency group and expands its capacity in bulk.

### BACKGROUND OF THE INVENTION

### 1. Field of the Invention

The present invention relates to a storage system and a method for managing copy performance of the storage system, and is suitably applied to, for example, a storage system involving a technology for expanding storage resources according to an increase in an amount of data written by a host.

### 2. Description of the Related Art

Recent years have seen the widespread use of software-defined storage (referred to as “SDS” hereinafter) in which a storage function is separated from hardware and provided by software. The SDS can implement the traditional storage function by setting up and operating a plurality of general-purpose servers without the need for what is called common storage nodes. The SDS adopts a scale-out configuration. For example, the number of storage nodes (referred to simply as “nodes” hereinafter) is increased, and volumes for use in applications and middleware are arranged in a distributed manner in a plurality of nodes to increase the degree of parallelism. With this configuration, the SDS can be used for applications and middleware such as databases that require high performance.

When a backup or disaster recovery (DR) solution is introduced, there are increasing cases where copy data is placed in a cloud to reduce costs. In such cases, the SDS may be installed in a cloud resource. This makes it possible to use a remote copy function for copying data asynchronously from volumes of on-premises storage nodes to data volumes of the SDS installed in the cloud.

In the case of asynchronously copying data by using the remote copy function as mentioned above, the data written by a host computer to a data volume is temporarily stored in a journal volume acting as a buffer region. In addition, data in a journal volume of a copy source is transmitted to a journal volume of a copy destination and is temporarily stored therein. The temporarily stored data is then written to a data volume of the copy destination. The data volumes and journal volumes of the copy source and copy destination are managed as a journal group. The remote copy is performed in units of the journal group, and hence, data traffic and input/output per second (IOPS) are generally acquired in units of the journal group in order to monitor whether the copy is being normally performed.

In a case where a database writes data to a plurality of data volumes, in order for the database to acquire and restore the copy data consistently, a plurality of copy pairs of data volumes are sometimes grouped together to perform copy management in units of what is called a consistency group that guarantees the order of written data. In the case of common storage nodes, even when there are a plurality of copy pairs, i.e., a plurality of data volumes, in the consistency group, these data volumes share a journal volume, so that the consistency group and the journal group are associated with each other on a one-on-one basis.

In designing the capacity of the journal volume in which data is temporarily stored, the journal volume capacity is determined by how long the writing of data from the host computer is desired to continue at the time when the remote copy is suspended due to a network failure, for example. In view of capacity efficiency, the journal volume capacity is not to be secured more than is necessary but needs to be expanded in keeping with operation status. However, since expanding the journal volume affects the suspension of data copy and the performance thereof, the frequency of such a capacity expansion needs to be minimized. With the SDS, in particular, the capacities of individual journal volumes are not designed in detail but are fixed at the start of operation for operational simplicity. This all the more requires expanding the journal volume capacity optimally according to operation, compared to the case of common storage nodes. According to JP-2008-304963-A, there is described a technology for monitoring performance in units of a pair of the copy source volume and the copy destination volume in a configuration using the remote copy function after the start of operation, and for setting a threshold.

Meanwhile, there is a configuration in which, in order to enable the scale-out of capacity and performance, copies of data written from the same database to different data volumes are transmitted to respective data volumes of different nodes in the SDS. In such a configuration, a consistency group includes a plurality of nodes in the SDS. In this case, a journal volume needs to be prepared for each node, so that a plurality of journal groups are present in one consistency group. In this configuration, reconfiguration is performed by acquiring monitoring information in units of the journal group and expanding the journal volumes in units of the journal group according to the result of monitoring based on the monitoring information, for example.

### SUMMARY OF THE INVENTION

However, depending on the conditions of use of applications for writing data, in a case where the amount of data written to the data volume of the copy source is increased, loads on all journal groups included in the consistency group tend to be high. Given such a trend of loads, if the journal volumes in the journal groups included in the consistency group are successively expanded a plurality of times, each expansion changes the configuration and thereby affects performance.

The present invention has been made in view of the above circumstances, and an object thereof is to propose a storage system capable of shortening a period of time that affects performance of the storage system, even in a case where a consistency group including a plurality of journal groups is adopted, and a method for managing copy performance of the storage system.

In order to solve the foregoing problem, according to one aspect of the invention, there is provided a storage system including a first storage system having a data volume to and from which data is written and read by a host computer and a second storage system having a plurality of storage nodes for storing a copy of data from the data volume of the first storage system. The first storage system as a copy source performs journaling at least at the time when data is written to the data volume, and defines at least one consistency group including a plurality of journal groups across the plurality of storage nodes. The first storage system performs, upon detecting that the usage rate of any one journal volume in the consistency groups has exceeded a threshold, tracing to identify one journal group to which the one journal volume belongs from among the plurality of journal groups and identify the consistency group to which the one journal group belongs, identifies at least one journal volume included in the identified consistency group, and expands the capacity of the at least one journal volume in bulk.

According to another aspect of the invention, there is provided a method for managing copy performance of a storage system that includes a first storage system having a data volume to and from which data is written and read by a host computer and a second storage system having a plurality of storage nodes for storing a copy of data from the data volume of the first storage system. The method includes, by the first storage system as a copy source, performing journaling at least at the time when data is written to the data volume, and defining at least one consistency group including a plurality of journal groups across the plurality of storage nodes. The method also include, by the first storage system, performing, upon detecting that the usage rate of any one journal volume in the consistency groups has exceeded a threshold, tracing to identify one journal group to which the one journal volume belongs from among the plurality of journal groups and identify the consistency group to which the one journal group belongs, identifying at least one journal volume included in the identified consistency group, and expanding the capacity of the at least one journal volume in bulk.

According to the present invention, it is possible to identify a consistency group including a journal volume whose usage rate has exceeded a threshold, and to expand the capacities of journal volumes in bulk in the consistency group. This can minimize a period of time that affects the performance of the storage system.

### BRIEF DESCRIPTION OF THE DRAWINGS

FIG. 1 is a view depicting an exemplary system configuration of a remote copy system;

FIG. 2 is a block diagram depicting an exemplary configuration of a storage management server;

FIG. 3 is a block diagram depicting an exemplary hardware configuration of a host computer;

FIG. 4 is a view depicting an exemplary data configuration of copy configuration information;

FIG. 5 is a view depicting an exemplary data configuration of journal volume capacity management information;

FIG. 6 is a view depicting an exemplary data configuration of SDS configuration information;

FIG. 7 is a flowchart depicting an exemplary procedure of a journal volume capacity expansion process according to an embodiment of the present invention;

FIG. 8 is a flowchart depicting an exemplary procedure of a process of determining whether or not to perform journal volume capacity expansion according to the embodiment;

FIG. 9 depicts exemplary trends of loads on data volumes of a copy source; and

FIG. 10 depicts exemplary trends of loads at the time of writing data to data volumes.

### DESCRIPTION OF THE PREFERRED EMBODIMENT

A preferred embodiment of the present invention will be described below in detail with reference to the accompanying drawings. It is to be noted that the present invention should not be interpreted as limited to the details of the embodiment to be described below. It will be apparent to those skilled in the art that specific configuration of the embodiment can be modified without departing from the concept or spirit of the present invention.

Throughout the description that follows, the same or similar constituent elements or functions are denoted by the same reference signs, and the explanations of such elements or functions will be omitted where they are redundant.

In the ensuing description, notations such as “the first,” “the second,” and “the third” are added solely to identify the constituent elements and may not necessarily restrict their number or order.

In the description that follows, any of various types of information may be explained by using such an expression as an “XX table” by way of example. However, such information may alternatively be expressed by using a data structure such as an “XX list” or an “XX queue.” Still alternatively, the “XX table” may be referred to as “XX information.” When identification information is explained by using expressions such as “identification information,” an “identifier (ID),” a “name,” or a “number,” these expressions are interchangeable.

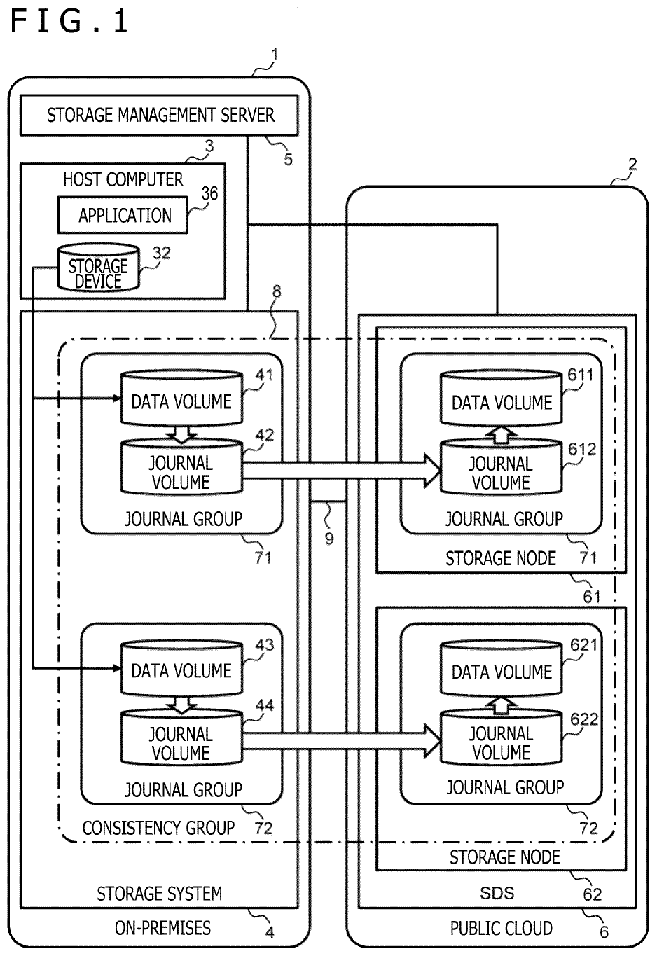

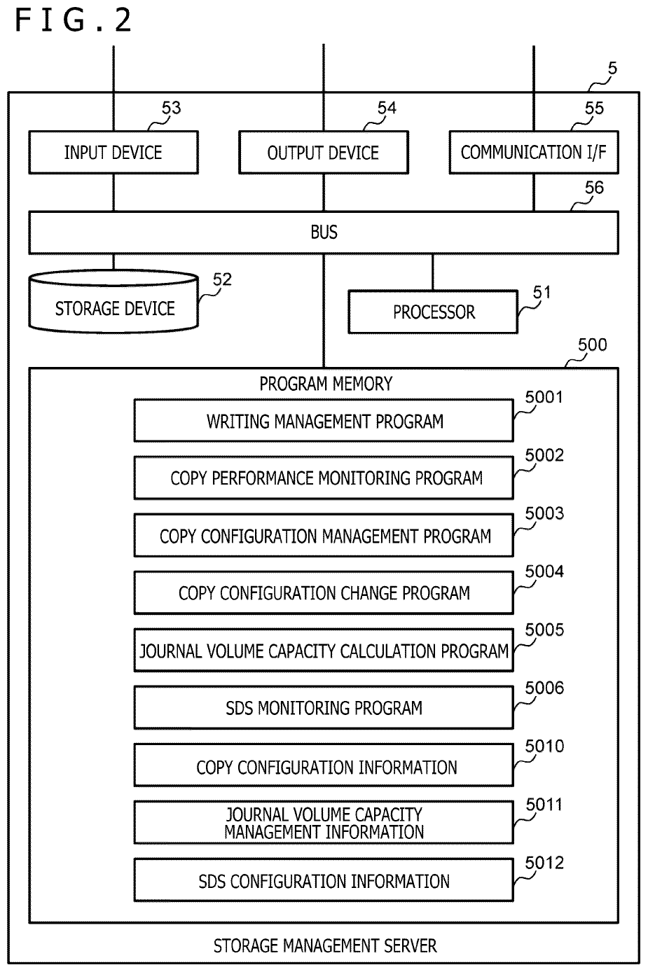

FIG. 1 is a view depicting an exemplary system configuration of a remote copy system. This configuration represents a system in which data is copied from a storage system 4 of an on-premises 1 to a public cloud 2 via a network 9 such as the Internet, a local area network (LAN), or a wide area network (WAN). FIG. 2 is a block diagram depicting an exemplary hardware configuration of a storage management server 5.

The on-premises 1 in FIG. 1 includes the storage system 4, the storage management server 5 that manages storage resources, and a host computer 3. The storage management server 5 may not necessarily be provided in the on-premises 1. Alternatively, the storage management server 5 may be provided in the public cloud 2, the storage system 4 of a copy source, or a cloud different from that of a copy destination. In a case where the storage management server 5 is provided in the storage system 4, the storage management server 5 and the storage system 4 correspond to a first storage system. In a case where a configuration having the storage management server 5 built in the storage system 4 is adopted, the storage system 4 may be used as the agent of processing performed by the storage management server 5. The storage system 4 has data volumes 41 and 43 and journal volumes 42 and 44. The data volumes 41 and 43 are provided to the host computer 3. The journal volumes 42 and 44 are used to temporarily store pieces of data written to the data volumes 41 and 43. The pieces of data written by the host computer 3 to the data volumes 41 and 43 are stored in the journal volumes 42 and 44 and are then transmitted asynchronously to storage on the cloud side.

The storage system 4 of the on-premises 1 and the public cloud 2 are communicably interconnected via the network. It is to be noted that, between the storage system 4 on the on-premises 1 and the public cloud 2, the communication rate (bps) is set according to the bandwidth in use.

The host computer 3 can use virtualized volumes as a drive of the computer. The host computer 3 executes applications and stores data generated by applications on a database (DB) in a storage device 32 in a virtual data volume.

In the public cloud 2, SDS 6 is created as an example of a second storage system on a server instance or storage instance provided by cloud services. The SDS 6 includes a plurality of storage nodes 61 and 62. The storage nodes 61 and 62 have data volumes 611 and 621 as the copy destination and journal volumes 612 and 622 in which pieces of copy data to be written to the data volumes 611 and 621 are temporarily stored.

The data written by the host computer 3 to the data volume 41 is temporarily stored in the journal volume 42 and is then transmitted to the journal volume 612 via the network 9. Thereafter, the data stored in the journal volume 612 is written to the data volume 611. The data volumes and journal volumes of the copy source and copy destination are grouped together and treated as a journal group. The data volume 41, the journal volume 42, the data volume 611, and the journal volume 612 are defined as a journal group 71. Likewise, the data volume 43, the journal volume 44, the data volume 621, and the journal volume 622 are defined as a journal group 72.

Data from applications running on the host computer 3 is written to the storage device 32. From the storage device 32, the data is written to a plurality of the data volumes 41 and 43. Since copies of the data written to the data volumes 41 and 43 need to be acquired as DB-consistent data, these copies need to be grouped together for management. A consistency group 8 treats these copies as a group for management purposes. In this configuration, a plurality of storage nodes are formed in the consistency group 8, and accordingly, a plurality of the journal groups 71 and 72 are configured in the consistency group 8.

In the remote copy system, the storage management server 5 copies data stored in the data volumes 41 and 43 to the public cloud 2 and restores copied data in the public cloud 2 to the storage system 4. Also, the storage management server 5 acquires the usage rates of the volumes in the storage system 4 and the SDS 6 and the performance information regarding copy progress rates, etc., to monitor whether remote copy is normally operating.

The storage system according to the present embodiment has the storage system 4 that includes the data volumes 41 and 43 to and from which data is written and read by the host computer 3, and the SDS 6 that includes the plurality of storage nodes 61 and 62 for storing copies of data from the data volumes 41 and 43 in the storage system 4.

A copy configuration management program 5003 in the storage management server 5 in FIG. 2 performs journaling at least at the time of writing data to the data volumes 41 and 43. The copy configuration management program 5003 is provided across the plurality of storage nodes 61 and 62 and defines at least one consistency group 8 that includes the plurality of journal groups 71 and 72. In the present embodiment, in a case where the consistency group 8 is defined to include the plurality of storage nodes 61 and 62, a plurality of journal groups are created in the consistency group 8.

Upon detecting that the usage rate of any one journal volume 42 in the consistency groups 8 has exceeded a threshold, a copy configuration change program 5004 in FIG. 2 performs tracing to identify one journal group 71 to which the one journal volume 42 belongs from among the plurality of journal groups 71 and 72 and identify the consistency group 8 to which the one journal group 71 belongs. The copy configuration change program 5004 then identifies at least one journal volume 44, 612, or 622 included in the consistency group 8 and expands the capacity of the at least one journal volume 44, 612, or 622 in bulk.

A journal volume capacity calculation program 5005 in FIG. 2 calculates, on the basis of the amounts of data written to the data volumes 41 and 43 of the copy source, the capacity of at least one journal volume 42, 44, 612, or 622 in units of the consistency group 8.

A copy performance monitoring program 5002 in FIG. 2 determines, upon detecting that the usage rate of any one journal volume 42 in the consistency groups 8 has exceeded a threshold, whether the excess of the usage rate of the one journal volume 42 above the threshold is caused by an increase in the amount of data written to the data volume 41. In a case where it is determined that the excess is caused by the increased amount of data written to the data volume 41, the relevant copy configuration change program 5004 expands the capacity of at least one journal volume 44, 612, or 622 in bulk as described above according to the increased amount of the written data, for example.

The copy configuration change program 5004 in FIG. 2 performs expansion of the capacity of at least one journal volume 44, 612, or 622 in a period of time when the amount of data being written to the data volume 41 is small.

Next, an exemplary configuration of the storage management server 5 is explained with reference to FIG. 2. The storage management server 5 includes a processor 51, a storage device 52, a program memory 500, an input device 53, an output device 54, and a communication interface (I/F) 55.

The processor 51, the storage device 52, the program memory 500, the input device 53, the output device 54, and the communication I/F 55 are interconnected by a bus 56. The processor 51 controls the storage management server 5. The input device 53 receives input of data. Examples of the input device 53 include a keyboard, a mouse, a touch panel, a tenkey pad, a scanner, a microphone, and a sensor. The output device 54 outputs data. Examples of the output device 54 include a display, a printer, and a speaker. The communication I/F 55 connects to the network for data transmission and reception. The storage device 52 is a storage medium that stores data in temporary or non-temporary fashion. Examples of the storage device 52 include a read-only memory (ROM), a random access memory (RAM), a hard disc drive (HDD), and a solid-state drive (SSD).

Installed in the program memory 500 are a writing management program 5001, the copy performance monitoring program 5002, the copy configuration management program 5003, the copy configuration change program 5004, the journal volume capacity calculation program 5005, and an SDS monitoring program 5006. The writing management program 5001 is a program that monitors input/output (IO) operations on the data volumes 41 and 43 and that records the result of the monitoring to a written data amount 50114 which is a field in journal volume capacity management information 5011 and which indicates the amount of data written to the volume of the copy source.

The copy performance monitoring program 5002 is a program that monitors the usage rates of the journal volumes 42 and 44 of the copy source and the journal volumes 612 and 622 of the copy destination and that raises an alert in a case where any of the usage rates has exceeded a threshold. The threshold may be set either by the system or by a user. The copy configuration management program 5003 is a program that manages the corresponding relations between the consistency groups 8, the journal groups, the copy source volumes, and the copy destination volumes in copy configuration information 5010.

The copy configuration change program 5004 changes the capacities of the journal volumes on the basis of the values recorded in the journal volume capacity management information 5011. The journal volume capacity calculation program 5005 is a program that calculates the capacities of the journal volumes on the basis of the amounts of data written by the host computer 3 to the data volumes 41 and 43 of the copy source, which have been acquired by the writing management program 5001, and records the results of the calculation to a required capacity 50115 which is a field in the journal volume capacity management information 5011 and which indicates the required capacity of the journal volume.

The SDS monitoring program 5006 is a program that monitors the capacity usage rate of a storage pool and the central processing unit (CPU) usage rate in the SDS. The program memory 500 holds the copy configuration information 5010, the journal volume capacity management information 5011, and SDS configuration information 5012. The configuration information will be described later in more detail.

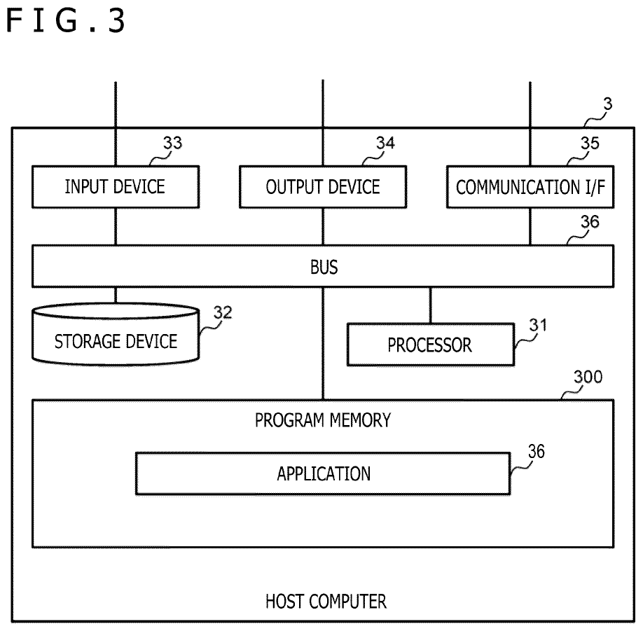

FIG. 3 is a block diagram depicting an exemplary hardware configuration of the host computer 3. The host computer 3 includes a processor 31, the storage device 32, a program memory 300, an input device 33, an output device 34, and a communication I/F 35.

The processor 31, the storage device 32, the program memory 300, the input device 33, the output device 34, and the communication I/F 35 are interconnected by a bus 36. The processor 31 controls the host computer 3. The input device 33 receives input of data. Examples of the input device 33 include a keyboard, a mouse, a touch panel, a tenkey pad, a scanner, a microphone, and a sensor.

The output device 34 outputs data. Examples of the output device 34 include a display, a printer, and a speaker. The communication I/F 35 connects to the network for data transmission and reception. The storage device 32 is a storage medium that stores data. Here, the data volumes 41 and 43 of the storage system 4 are mounted for use as the storage device 32. Applications are installed in the program memory 300.

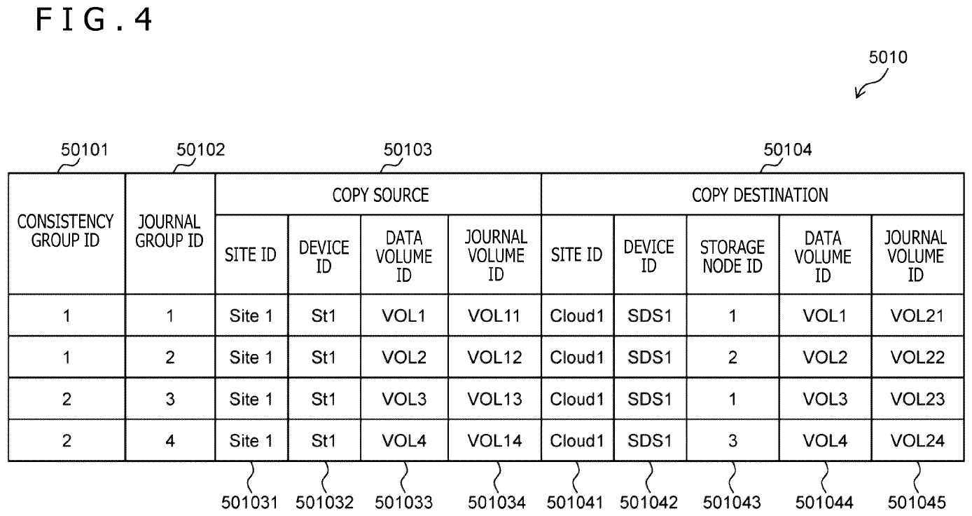

Next, the data configurations of various types of data are explained with reference to FIGS. 4 through 6. It is to be noted that the configurations of the copy configuration information 5010, the journal volume capacity management information 5011, and the SDS configuration information 5012 are only examples and can be changed as needed.

FIG. 4 is a view depicting an exemplary data configuration of the copy configuration information 5010. The copy configuration information 5010 manages the corresponding relations between the consistency groups 8, the journal groups, the data volumes and journal volumes of the copy source in the journal groups, and the data volumes and journal volumes of the copy destination in the journal groups.

The copy configuration information 5010 manages a consistency group ID 50101 which is identification information for identifying each of the plurality of consistency groups 8, a journal group ID 50102 which is identification information for identifying each of the plurality of journal groups, copy source information 50103, and copy destination information 50104.

The consistency group ID 50101 is a field that holds IDs for identifying the plurality of consistency groups 8 from each other. The journal group ID 50102 is a field that holds IDs for identifying the journal groups corresponding to the consistency groups 8 recorded in the consistency group ID 50101.

The copy source information 50103 is a field that includes a site ID 501031, a device ID 501032, a data volume ID 501033, and a journal volume ID 501034, which are related to the copy source sites for remote copy.

The copy destination information 50104 is a field that includes a site ID 501041, a device ID 501042, a storage node ID 501043, a data volume ID 501044, and a journal volume ID 501045, which are related to the copy destination sites for remote copy.

The site ID 501031 is a field that holds IDs for identifying a plurality of sites from each other. The device ID 501032 is a field that holds IDs for identifying the storage nodes 61 and 62. The data volume ID 501033 is a field that holds IDs for identifying a plurality of data volumes from each other.

The journal volume ID 501034 is a field that holds IDs for identifying a plurality of journal volumes from each other. The site ID 501041 is a field that holds information regarding the sites. The device ID 501042 is a field that holds IDs for identifying the storage nodes and SDSs.

The storage node ID 501043 is a field that holds IDs for identifying the storage nodes associated with the SDSs. The data volume ID 501044 is a field that holds IDs for identifying a plurality of data volumes from each other. The journal volume ID 501045 is a field that holds IDs for identifying a plurality of journal volumes from each other.

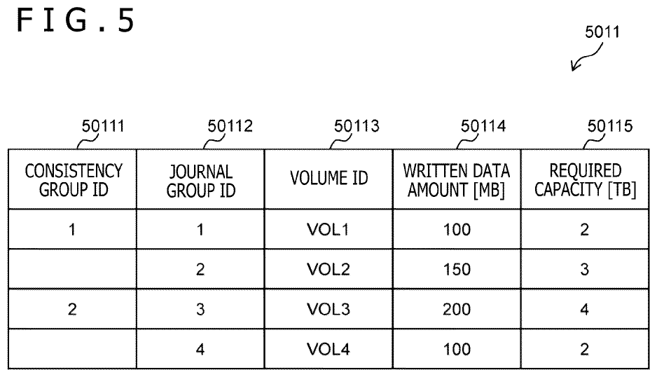

FIG. 5 is a view depicting an exemplary data configuration of the journal volume capacity management information 5011. The journal volume capacity management information 5011 manages a consistency group ID 50111, a journal group ID 50112, a volume ID 50113, the written data amount 50114, and the required capacity 50115.

The consistency group ID 50111 is a field that holds IDs for identifying the consistency groups 8. The journal group ID 50112 is a field that holds IDs for identifying the journal groups corresponding to the consistency groups 8 recorded in the consistency group ID 50111. The volume ID 50113 is a field that holds IDs for identifying the data volumes of the copy source.

The written data amount 50114 is a field that holds the amounts of data written by the host computer 3 to the data volumes indicated by the volume ID 50113. The amounts of data written by the host computer 3 to the data volumes are acquired by the writing management program 5001. The required capacity 50115 is a field that holds the required capacities of the data volumes calculated by the journal volume capacity calculation program 5005 on the basis of the written data amounts held in the written data amount 50114.

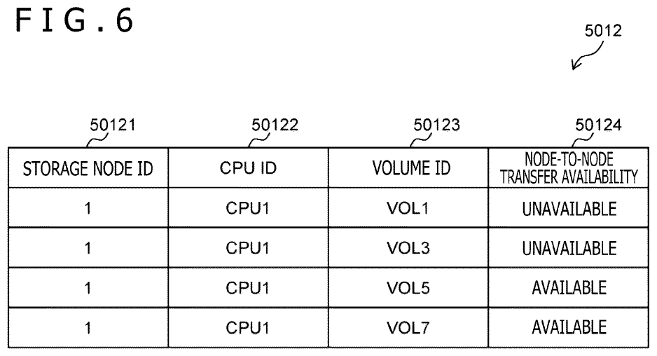

FIG. 6 is a view depicting an exemplary data configuration of the SDS configuration information 5012. The SDS configuration information 5012 manages a storage node ID 50121, a CPU ID 50122, a volume ID 50123, and node-to-node transfer availability 50124.

The storage node ID 50121 is a field that holds IDs for identifying a plurality of storage nodes from each other. The CPU ID 50122 is a field that holds IDs for identifying the CPUs incorporated in the storage nodes recorded in the storage node ID 50121.

The volume ID 50123 is a field that holds IDs for identifying the a plurality of data volumes from each other which are used by the storage nodes identified by the storage node ID 50121. The volumes recorded in the volume ID 50123 include not only the data volumes and journal volumes which are used in the remote copy and which are managed in the copy configuration information 5010, but also data volumes used in other than remote copy.

The node-to-node transfer availability 50124 is a field that indicates whether the data volume identified by the volume ID 50123 can be transferred to another storage node. The value representing the transfer availability may be input by the user. For example, in the node-to-node transfer availability 50124, a value related to a certain data volume recorded in the volume ID 50123 may be set to “unavailable” in a case where the transfer of the corresponding data volume between storage nodes affects, i.e., degrades, its performance and where the user does not intend to lower the performance of the corresponding data volume.

At the time of remote copy connection, a storage node is designated to set up the remote path connection. Therefore, in a case where it is determined that the transfer of a data volume recorded in the volume ID 50123 to another storage node cannot be made, the corresponding data volume, i.e., the data volume being used in remote copy, may be set to “unavailable” for transfer to any other storage node.

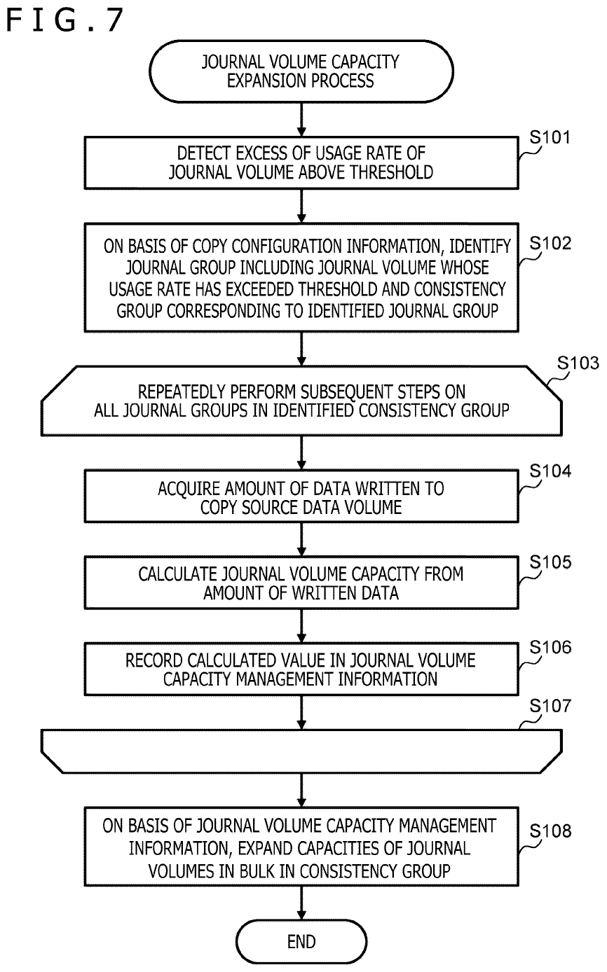

FIG. 7 is a flowchart depicting an exemplary procedure of a journal volume capacity expansion process according to the present embodiment. First, an exemplary method for managing the copy performance of the storage system according to the present embodiment is explained. This copy performance management method is a method for managing the copy performance of the storage system that includes the storage system 4, which is an example of the first storage system having the data volumes to and from which data is written and read by the host computer 3, and the SDS 6, which is an example of the second storage system having the plurality of storage nodes 61 and 62 for storing copies of data from the data volumes of the storage system 4. According to this copy performance management method, the storage system 4 as the copy source performs journaling at least at the time when data is written to the data volumes 41 and 43, and defines at least one consistency group 8 that includes the plurality of journal groups 71 and 72 across the plurality of storage nodes 61 and 62. Upon detecting that the usage rate of any one journal volume 42 in the consistency groups 8 has exceeded a threshold, the storage system 4 as the copy source performs tracing to identify one journal group 71 to which the one journal volume 42 belongs from among the plurality of journal groups 71 and 72 and identify the consistency group 8 to which the one journal group 71 belongs. The storage system 4 then identifies at least one journal volume 44, 612, or 622 included in the consistency group 8 and expands the capacity of the at least one journal volume 44, 612, or 622 in bulk.

In the present embodiment, when the usage rate of any one journal volume has exceeded a threshold, the following process is started. In the storage management server 5, the copy performance monitoring program 5002 detects that the capacity usage rate of the journal volume has exceeded a threshold (step S101). In a case where the copy performance monitoring program 5002 does not detect the excess of the capacity usage rate of any journal volume above the threshold, the journal volume capacity expansion process is not performed.

Next, on the basis of the copy configuration information 5010, the copy configuration management program 5003 identifies one journal group to which the journal volume whose capacity usage rate has exceeded the threshold belongs, and identifies the consistency group 8 to which the identified journal group belongs (step S102).

The subsequent steps are repeatedly performed on all journal groups in the consistency group 8 identified in step S102 (step S103). The writing management program 5001 acquires the amount of data written to the data volume of the copy source.

Here, the writing management program 5001 may acquire the amount of data actually written at this point in time, or may acquire a predicted amount of data that will be written in a month, etc., in a case where the future trend can be predicted from the current trend such as an increasing trend, for example (step S104). The journal volume capacity calculation program 5005 calculates the capacity of the journal volume on the basis of the written data amount acquired in step S104 (step S105).

In a case where “t” represents a period of time in which the host computer 3 can continuously write data to the storage system 4 during suspension of the remote copy and where “VH-M” represents the rate of data transmission from the host computer 3 to the copy source storage, the journal volume capacity can be calculated by use of the following formula (1).

$$VH - M \times t \qquad ( 1 )$$

The copy configuration management program 5003 records the value of the written data amount calculated in step S105, in the required capacity 50115 of the journal volume capacity management information 5011 (step S106).

The copy configuration management program 5003 terminates the repetitive processing (steps S104 through S106) started in step S103 (step S107). On the basis of the values recorded in the required capacity 50115 of the journal volume capacity management information 5011, the copy configuration change program 5004 expands the capacities of all journal volumes in bulk in the consistency group (step S108). The expansion of journal volumes involves the suspension of copy and the degradation of performance. Therefore, in order to minimize adverse effects on operation, the trend of data being written in the consistency groups 8 may be checked, and the capacity expansion may be performed in a period of time when the amount of data being written is as small as possible.

In the example described above, the processing of step 2 and the subsequent steps is started at a timing when the excess of the capacity usage rate of a journal volume above the threshold is detected in step 1. Alternatively, the trend of the usage rate of each journal volume may be monitored, and in a case where the trend is on the increase, the processing of step 2 and the subsequent steps may be performed even when the usage rate has not exceeded the threshold.

In the example of the embodiment described so far, the capacities of the journal volumes are expanded. In a case where the amounts of data written to the journal volumes is always small and such a situation continues, however, the amounts of data written to all the consistency groups 8 can be expected to be small. In such a case, a scale-back process may be performed in view of capacity efficiency. As with the expansion process, the scale-back process is performed in units of the consistency group 8. Here, the scale-back includes, for example, reducing the capacities of journal volumes.

That is, upon detecting that the usage rate of one journal volume 42 has not exceeded a predetermined value over a predetermined period of time, the copy configuration change program 5004 performs tracing to identify one journal group 71 to which the one journal volume 42 belongs from among the plurality of journal groups 71 and 72 and identify the consistency group 8 to which the one journal group 71 belongs. The storage node 61 then identifies at least one journal volume 44, 612, or 622 included in the consistency group 8 and reduces the capacity of the at least one journal volume 44, 612, or 622 in bulk. It is to be noted that the predetermined value may or may not be the same as the above-mentioned threshold.

In a case where a threshold or like value related to the usage rate of each journal volume is set for capacity reduction and where the usage rate has not exceeded that value over a predetermined period of time, the consistency group 8 to which the corresponding journal volume belongs may be identified, the amounts of data written to all data volumes of the copy source in the consistency group 8 may be acquired, and the journal volume capacities may be reduced in bulk on the basis of the written data amounts.

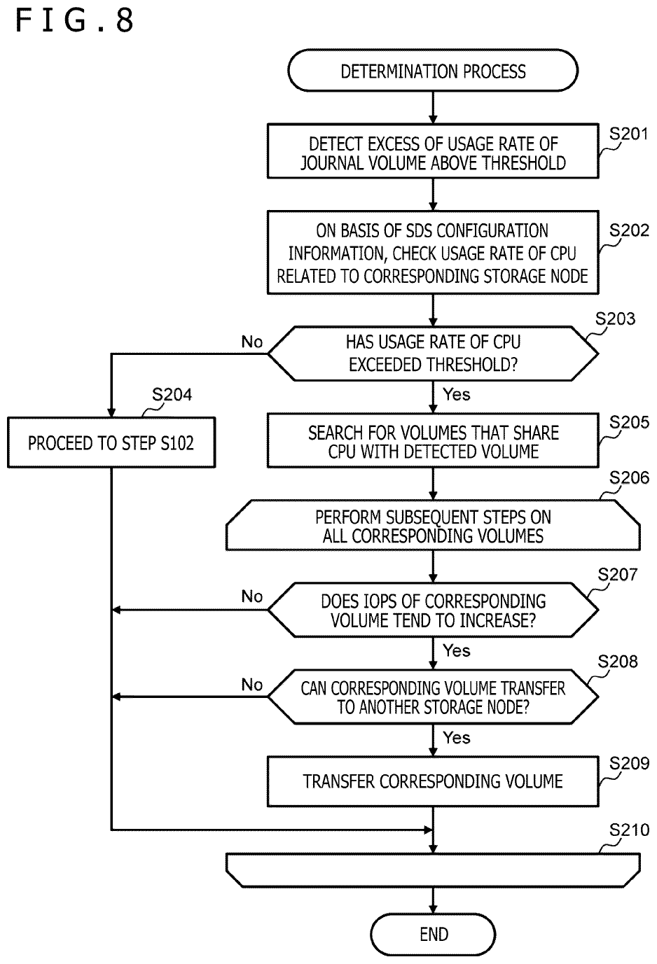

FIG. 8 is a flowchart depicting an exemplary procedure of a process of determining whether or not to perform the journal volume capacity expansion according to the embodiment. Given here is an example of how to perform the determination process and deal with a case where the excess of the usage rate of the journal volume above the threshold is not caused by an increased amount of data written by the host computer 3 to the data volume of the copy source.

The determination process may be started after step S101 in FIG. 7 and performed to determine whether to perform the expansion in units of the consistency group 8. Alternatively, the determination process may be started when any increase in the amounts of data written to the copy source data volumes in all journal groups is not confirmed in step S104.

The copy performance monitoring program 5002 in the storage management server 5 detects that the usage rate of a journal volume has exceeded a threshold (step S201). By referencing the volume ID 50123 and the CPU ID 50122 of the SDS configuration information 5012, the SDS monitoring program 5006 identifies the CPU related to the relevant journal volume and acquires the usage rate of the identified CPU (step S202).

The SDS monitoring program 5006 checks whether the usage rate of the identified CPU has exceeded a threshold (step S203). In a case where the usage rate of the CPU has not exceeded the threshold, the process proceeds to step S102 in the flowchart of FIG. 7 (step S204).

In contrast, in a case where the CPU usage rate has exceeded the threshold, the SDS monitoring program 5006 searches for the data volumes that share the CPU with the data volume detected in step S201, by referencing the volume ID 50123 of the SDS configuration information 5012 (step S205). The SDS monitoring program 5006 repeatedly perform the subsequent steps on all data volumes searched for in step S205 (step S206).

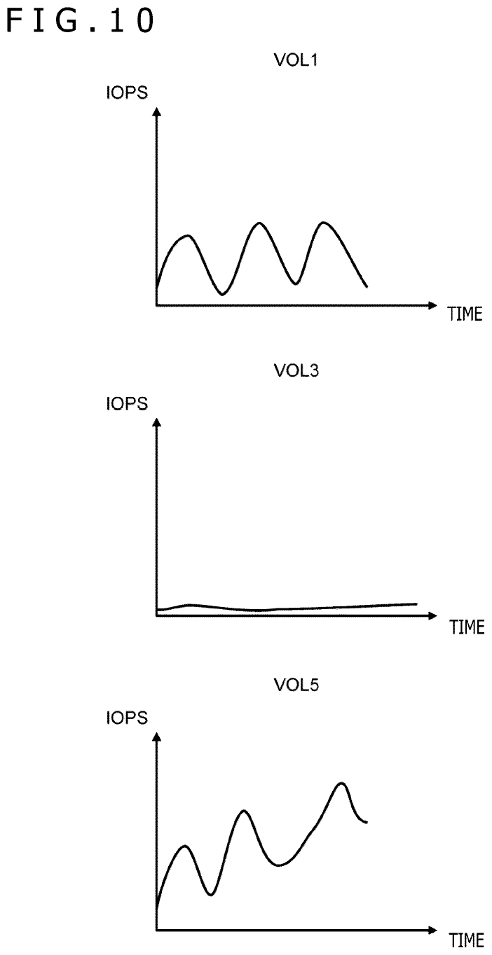

From IOPS information of the data volumes (see FIG. 10), the SDS monitoring program 5006 determines whether IOPS of the corresponding data volume tends to increase (step S207). In a case where it is determined in step S207 that the IOPS does not tend to increase (“No” in the determination in step S207), the process proceeds to step S204 and then to step S102. In a case where it is determined in step S207 that the IOPS tends to increase (“Yes” in the determination in step S207), the process proceeds to step S208.

On the basis of the SDS configuration information 5012, the SDS monitoring program 5006 determines whether the corresponding data volume can transfer to another storage node (step S208). In a case where it is determined in step S208 that the transfer to another storage node is not available (“No” in the determination in step S208), the process proceeds to step S204 and then to step S102.

In a case where it is determined in step S208 that the transfer to another storage node is available (“Yes” in the determination in step S208), the process proceeds to step S209. The corresponding data volume is transferred to another storage node (step S209).

The data volume is transferred to a storage node that is determined to have an extra capacity and a performance margin on the basis of the CPU usage rate of each storage node, the usage rates of the data volumes, and the IOPS information, which are acquired by the SDS monitoring program 5006. The repetitive processing started in step S206 is then terminated (step S210). The transfer of the data volume in step S209 may be performed in a period of time when the amount of data written to the relevant data volume is small.

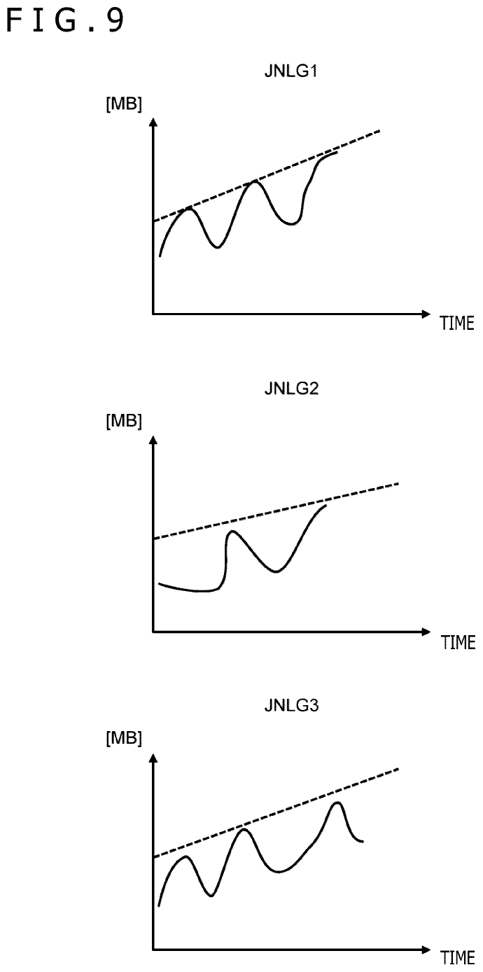

FIG. 9 depicts exemplary trends of loads on data volumes of the copy source. Examples in FIG. 9 graphically indicate the values of the amounts of data written to the data volumes of the copy source, which are acquired by the writing management program 5001. In the graphs, solid lines represent the values of the amounts of written data, and broken lines represent the trends of the written data amounts.

It is possible to predict the future values of the amounts of data that will be written to the data volumes of the copy source, by outputting future trends on the basis of the amounts of data written in the past. Thus, in a case where an increase in the capacities of journal volumes is expected in the near future, the capacities of the journal volumes can be expanded in advance even though there is no need to expand the capacities at present on the basis of the current written data amounts.

Further, by outputting the future trends in units of the consistency group 8, it is possible to identify a period of time when the amounts of data written to all data volumes of the copy source in the consistency group 8 are small. For example, the journal volume capacity expansion process in FIG. 7 may be performed after identifying the period of time when the amounts of data written to the entire the consistency group 8 are small. This can minimize adverse effects on operation when the capacity of any journal volume is expanded.

FIG. 10 depicts exemplary trends of loads at the time of writing data to data volumes. Examples in FIG. 10 graphically indicate the values of the amounts of data written to data volumes that have volume names “VOL1,” “VOL3,” and “VOL5” and that are associated with the storage node. In the graphs, solid lines represent the values of the amounts of written data. The written data amounts are acquired by the SDS monitoring program 5006.

The written data amounts acquired by the SDS monitoring program 5006 are used to determine in step S207 which data volume has an increasing trend of IOPS. The written data amounts are also used to calculate the required volume capacity on the basis of the acquired IOPS, to select the storage node of the transfer destination, and to determine whether or not expansion of the storage nodes in the storage system is available.

The storage system according to the present embodiment includes the first storage system having the data volumes to and from which data is written and read by the host computer and the second storage system having the plurality of storage nodes 61 and 62 for storing copies of data from the data volumes of the first storage system. The first storage system as the copy source includes the storage management server 5, for example. The first storage system performs journaling at least at the time when data is written to the data volumes 41 and 43, and defines at least one consistency group 8 that includes the plurality of journal groups 71 and 72 across the plurality of storage nodes 61 and 62. Upon detecting that the usage rate of any one journal volume 42 in the consistency groups 8 has exceeded a threshold, the first storage system performs tracing to identify one journal group 71 to which the one journal volume 42 belongs from among the plurality of journal groups 71 and 72 and identify the consistency group 8 to which the one journal group 71 belongs, identifies at least one journal volume 44, 612, or 622 included in the consistency group 8, and expands the capacity of the at least one journal volume 44, 612, or 622 in bulk.

With the above configuration, a period of time that affects the performance of the storage system is shortened even in a case where the consistency group 8 including a plurality of journal groups is adopted.

In the present embodiment, on the basis of the amounts of data written to the data volume 41 or 43 of the copy source, the first storage system calculates the capacity of at least one journal volume 44, 612, or 622 in units of the consistency group 8. This makes it possible to accurately obtain the capacity to be expanded, and to shorten the period of time that affects the performance of the storage system, even in the case where the consistency group 8 including a plurality of journal groups is adopted.

In the present embodiment, upon detecting that the usage rate of any one journal volume 42 in the consistency groups 8 has exceeded a threshold, the first storage system determines whether the excess of the usage rate of the one journal volume 42 above the threshold is caused by an increase in the amount of data written to the data volume 41. With this configuration, in a case where it is determined that the excess is caused by the increased amount of data written to the data volume 41, the storage system 4 as the copy source expands the capacity of at least one journal volume 44, 612, or 622 in bulk as described above according to the increased amount of the written data, for example. In this manner, the period of time that affects the performance of the storage system is shortened even in the case where the consistency group 8 including a plurality of journal groups is adopted.

In the present embodiment, the first storage system expands the capacity of at least one journal volume 44, 612, or 622 in a period of time when the amount of data being written to the data volume 41 is small. In this manner, the period of time that affects the performance of the storage system is shortened even in the case where the consistency group 8 including a plurality of journal groups is adopted.

That is, upon detecting that the usage rate of one journal volume 42 has not exceeded a predetermined value over a predetermined period of time, the first storage system performs tracing to identify one journal group 71 to which the one journal volume 42 belongs from among the plurality of journal groups 71 and 72 and identify the consistency group 8 to which the one journal group 71 belongs, identifies at least one journal volume 44, 612, or 622 included in the consistency group 8, and reduces the capacity of the at least one journal volume 44, 612, or 622 in bulk. In this manner, the period of time that affects the performance of the storage system can be shortened not only in a case where the capacity is expanded as described above but also in a case where the capacity is reduced while the consistency group 8 including a plurality of journal groups is adopted.

It is to be noted that the present invention is not limited to the embodiment described above and includes various modifications. Further, the configuration of the above embodiment has been described in detail for an easier understanding of the present invention, for example, and the present invention should not necessarily be limited to anything that includes all the configurations described above. In addition, part of the configuration of each embodiment can be added to, removed, or replaced with another configuration. Moreover, the elements described parallelly in the foregoing embodiment may be arranged in such a manner that at least one of the elements is connected in series to another element.

In the embodiment described above, the on-premises 1 has the storage system 4 that has no storage node, but is not limited thereto. Alternatively, the on-premises 1 may include storage nodes by adopting software-defined storage such as the SDS 6. In this case, an SDS-SDS remote copy configuration may be provided between the on-premises 1 and the public cloud 2.

Further, some or all of the above-described configurations, functions, processing units, and processing means may be implemented in hardware by an integrated circuit design, for example. In addition, the present invention can be implemented by using a software program code that implements the functions of the embodiment. In this case, a recording medium with the program code recorded thereon is provided to a computer, and a processor included in the computer reads the program code from the storage medium. The program code thus retrieved from the storage medium implements the functions of the embodiment described above. In this instance, the program code and the recording medium having the program code recorded thereon constitute the present invention. The recording medium used to provide the program code may be a flexible disc, a compact-disc read-only memory (CD-ROM), a digital versatile disc read-only memory (DVD-ROM), a hard disc, an SSD, an optical disc, a magneto-optical disc, a compact disc-readable (CD-R), a magnetic tape, a nonvolatile memory card, or a ROM, for example.

In addition, the program code that implements the functions described in the foregoing embodiment may be written in diverse programming or scripting languages such as assembler, C/C++, perl, Shell, PHP, Python, and Java (registered trademark).

Moreover, the software program code for implementing the functions of the embodiment may be distributed via networks and stored into storage means such as hard disc or a memory of a computer or a storage medium such as a compact disc-rewritable (CD-RW) or a CD-R. The program code thus stored in the storage means or storage medium may be retrieved therefrom by a processor of the computer for execution.

The present invention can be applied to storage systems related to technologies for expanding storage resources according to an increased amount of data written by the host.

What is claimed is:

1. A storage system comprising:
a first storage system having a data volume to and from which data is written and read by a host computer; and
a second storage system having a plurality of storage nodes for storing a copy of data from the data volume of the first storage system, wherein
the first storage system as a copy source
performs journaling at least at a time when data is written to the data volume,
defines at least one consistency group including a plurality of journal groups across the plurality of storage nodes, and
performs, upon detecting that a usage rate of any one journal volume in the consistency groups has exceeded a threshold, tracing to identify one journal group to which the one journal volume belongs from among the plurality of journal groups and identify the consistency group to which the one journal group belongs, identifies at least one journal volume included in the identified consistency group, and expands a capacity of the at least one journal volume in bulk.

2. The storage system according to claim 1, wherein
the first storage system calculates the capacity of the at least one journal volume in units of the consistency group on a basis of an amount of data written to the data volume of the copy source.

3. The storage system according to claim 1, wherein
the first storage system determines, upon detecting that the usage rate of the one journal volume in the consistency groups has exceeded the threshold, whether the excess of the usage rate of the one journal volume above the threshold is caused by an increase in an amount of data written to the data volume.

4. The storage system according to claim 1, wherein
the first storage system expands the capacity of the at least one journal volume in a period of time when an amount of data being written to the data volume is small.

5. The storage system according to claim 1, wherein
the first storage system performs, upon detecting that the usage rate of the one journal volume has not exceeded a predetermined value over a predetermined period of time, tracing to identify the one journal group to which the one journal volume belongs from among the plurality of journal groups and identify the consistency group to which the one journal group belongs, identifies at least one journal volume included in the identified consistency group, and reduces the capacity of the at least one journal volume in bulk.

6. A method for managing copy performance of a storage system that includes a first storage system having a data volume to and from which data is written and read by a host computer and a second storage system having a plurality of storage nodes for storing a copy of data from the data volume of the first storage system, the method comprising:
by the first storage system as a copy source,
performing journaling at least at a time when data is written to the data volume;
defining at least one consistency group including a plurality of journal groups across the plurality of storage nodes; and
performing, upon detecting that a usage rate of any one journal volume in the consistency groups has exceeded a threshold, tracing to identify one journal group to which the one journal volume belongs from among the plurality of journal groups and identify the consistency group to which the one journal group belongs, identifying at least one journal volume included in the identified consistency group, and expanding a capacity of the at least one journal volume in bulk.

7. The method for managing the copy performance according to claim 6, further comprising:
by the first storage system,
calculating the capacity of the at least one journal volume in units of the consistency group on a basis of an amount of data written to the data volume of the copy source.

8. The method for managing the copy performance according to claim 6, further comprising:
by the first storage system,
determining, upon detecting that the usage rate of the one journal volume in the consistency groups has exceeded the threshold, whether the excess of the usage rate of the one journal volume above the threshold is caused by an increase in an amount of data written to the data volume.

9. The method for managing the copy performance according to claim 6, further comprising:
by the first storage system,
expanding the capacity of the at least one journal volume in a period of time when an amount of data being written to the data volume is small.

10. The method for managing the copy performance according to claim 6, further comprising:
by the first storage system,
performing, upon detecting that the usage rate of the one journal volume has not exceeded a predetermined value over a predetermined period of time, tracing to identify the one journal group to which the one journal volume belongs from among the plurality of journal groups and identify the consistency group to which the one journal group belongs, identifying at least one journal volume included in the identified consistency group, and reducing the capacity of the at least one journal volume in bulk.
